(19) United States
(12) Patent Application Publication
(10) Pub. No.: US 2024/0356783 A1
(43) Pub. Date: Oct. 24, 2024

(54) DETECTION OF PULSED RADAR SIGNAL

(71) Applicant: Telefonaktiebolaget LM Ericsson (PUBL), Stockholm (SE)

(72) Inventors: Dennis Hui, SUNNYVALE, CA (US); Kumar Balachandran, PLEASANTON, CA (US)

(21) Appl. No.: 18/685,354

(22) PCT Filed: Aug. 30, 2022
(86) PCT No.: PCT/IB2022/058113

§ 371 Date: Feb. 21, 2024

Related U.S. Application Data
(60) Provisional application No. 63/238,264, filed on Aug. 30, 2021.
(60) Provisional application No. 63/238,566, filed on Aug. 30, 2021.

(51) Int. Cl. H04L 25/02; G01S 3/02; H04L 27/00

(52) U.S. Cl. CPC H04L 25/024; G01S 3/02; H04L 27/0014; H04L 2027/0034

(57) ABSTRACT

According to some embodiments, a method performed by a network node comprises receiving a plurality of radio signal samples; estimating parameters for a first hypothesis function, the first hypothesis function hypothesizing that that the plurality of radio signal samples only contains background noise; estimating parameters for a second hypothesis function, the second hypothesis function hypothesizing that that the plurality of radio signal samples contains background noise plus one or more radio pulses; performing a log-likelihood ratio test for the first hypothesis function and the second hypothesis function; and based on the log-likelihood ratio test, determining whether a radio pulse is present in the plurality of radio signal samples.

### TECHNICAL FIELD

Particular embodiments relate to wireless communication, and more specifically to detection of radar signals in wireless networks.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

The scarcity of spectrum for mobile networks has led regulators to consider shared spectrum between a mobile network and an incumbent service, such as radar. The requirements for sharing are that the mobile network needs to vacate spectrum in use by the incumbent service. The presence of the incumbent signal may be obtained through an external sensor network. This is the case with the citizens broadband radio service (CBRS) band in the United States (US). The incumbent signal may also be detected directly by a receiver of a network node acting as a sensor. This is the case with Wi-Fi in unlicensed spectrum where sharing occurs with dynamic frequency selection (DFS).

In the examples above, the incumbent service is typically present for a relatively long time and affects a relatively large geographical area. There is new interest in sharing spectrum with airborne radar. This is the case with the lower 3 GHz band in the US. Similar to the CBRS band, these radars have limited but significant geographical reach and may operate for limited duration per event, although shorter. The signal may affect a relatively small area of a nationwide network and only temporarily. However, the radar has the potential of operating in the midst of populated areas.

When sharing spectrum with mobile networks, the radar event must be detected quickly and accurately to enable the mobile network to react to the presence of the radar signal to: 1) assess the impact of the interference to the mobile network and the effect of the network on radar receivers, 2) avoid harmful interference to the radar receiver 3) adjust the operation of the network to manage the degradation of performance to mobile network operation, and 4) vacate the spectrum before it interferes with the radar receiver. This requires a different approach that boosts detection speed and reliability.

There currently exist certain challenges. For example, aside from being a pulsed signal, the radar signal to be detected typically has unknown characteristics. Consequently, blind estimation of parameters pertaining to the radar signal is needed. Traditional radar detectors rely on the detection of a sudden rise in received signal power without deliberate estimation of radar signal parameters. In this approach, the specific threshold used for deciding whether sufficient signal power has been observed can be greatly affected by the gains of amplifiers in the network receiver front-end. Also, traditional radar detectors assume the use of a single receive antenna and do not distinguish the direction of arrival of the radar signal. However, when an antenna array is available at the receiver, the ability to identify the direction of arrival of the radar signal can greatly improve detection performance.

### SUMMARY

As described above, certain challenges currently exist with detecting pulsed radar signals in wireless networks. Certain aspects of the present disclosure and their embodiments may provide solutions to these or other challenges. Particular embodiments detect the presence of a periodic pulse signal, commonly used in a radar signal (e.g., an airborne radar), over background noise or interference, such as the residual signal obtained by removing an estimated or known signal from the received signal.

Given a block of observed signal, particular embodiments use a detection decision metric that implicitly computes the maximum likelihood estimates of any specified group of parameters that characterize the pulsed signal, which may include one or more of the set of parameters: start or the end of the train of pulses, the width(s) of the pulses, the spacing(s) between adjacent pulses, the pulse power as well as the background noise/interference power. The decision metric applies to any general arrangement of on-off pulses as long as the arrangement can be characterized by the specified group of parameters.

The decision metric implicitly partitions the received signal samples into two sets, one corresponding to the time when radar pulse is on and the other corresponding to the time when radar pulse is off. The decision metric is derived based on a generalized log-likelihood ratio test that minimizes the probability of missed detection for any given target probability of false-alarm probability, or equivalently minimizes the probability of false alarm probability for any given target probability of missed detection. The resulting metric indicates how different the power of the signal over the detected pulse locations is from the power of the signal where no pulse is present. The metric is invariant to any amplification or scaling of the received signal, and thus a fixed decision threshold can be selected independently of the amplifier or channel gains.

In general, particular embodiments include a decision metric for hypothesis testing on whether a radar signal exists that measures how different the power of the signal over the duration of detected pulse location is from the power of the signal over the duration where the pulse is absent. Particular embodiments may be applied to any predefined structure of pulses (e.g., a single pulse or a finite train of multiple pulses) and provide a method for estimating the group of parameters that characterize the predefined structure by optimizing an objective function of the parameters.

Some embodiments may benefit from multiple receive antennas. For example, given a block of signal observed over multiple antennas residing on an antenna panel, particular embodiments use a detection decision metric that implicitly computes the maximum likelihood estimates of a spatial parameter vector that characterizes the channel, as well as the direction of arrival, between the radar transmitter and the receiver. Some embodiments are particularly beneficial when the radar signal is transmitted from the air (e.g., from an airborne warning and control system (AWACS) aircraft) where there is a direct line-of-sight between the transmitter and the receiver.

Particular embodiments work with any pre-processing function that estimates the time and/or frequency locations of the pulsed radio signal, such as the start or the end of the train of pulses, the width(s) of the pulses in time, the temporal spacing(s) between adjacent pulses, the center frequency, and the bandwidth of the pulses. The decision metric is derived based on a generalized log-likelihood ratio test that minimizes the probability of missed detection for any given target probability of false-alarm probability, or equivalently minimizes the probability of false alarm probability for any given target probability of missed detection. The resulting decision metric indicates how different the power of the signal at a particular direction of arrival or with a particular spatial combining weight vector (or underlying channel response) can be from the power of the signal averaged over all other directions or spatial combining weights (or underlying channel responses). The metric is also invariant to any amplification or scaling of the received signal, and thus a fixed decision threshold can be selected independently of the amplifier or channel gains.

Some embodiments include methods of constraining the direction of arrival or the spatial combining weights based on the expected location of the radar transmitter and/or on the typical configuration of the antenna array at the receiver.

In general, particular embodiments include a decision metric for hypothesis testing on whether a radar signal exists that measures how different the power of the received signal at a particular direction of arrival or with a particular spatial combining weight vector (or underlying channel response) can be from the power of the signal averaged over all other directions of arrival or spatial combining weight vectors (or underlying channel responses). Particular embodiments can be applied to any configurations of the antenna array at the receiver and provide a method for estimating the optimal vector of spatial combining weights that can be applied to received signals from the antennas to maximize the signal-to-noise ratio in the detection process.

Practical considerations are also given in some embodiments to improve the performance and/or to reduce the computational complexity by using the expected location of the transmitter of radar signal and/or the typical configuration of the antenna array at the receiver.

According to some embodiments, a method performed by a network node comprises receiving a plurality of radio signal samples; estimating parameters for a first hypothesis function, the first hypothesis function hypothesizing that the plurality of radio signal samples only contains background noise; estimating parameters for a second hypothesis function, the second hypothesis function hypothesizing that the plurality of radio signal samples contains background noise plus one or more radio pulses; performing a log-likelihood ratio test for the first hypothesis function and the second hypothesis function; and based on the log-likelihood ratio test, determining whether a radio pulse is present in the plurality of radio signal samples.

In particular embodiments, estimating parameters for the first and the second hypothesis functions comprises using a maximum likelihood estimate for each parameter. Estimating parameters for the first and the second hypothesis functions may comprise estimating any one or more of a start or the end of the one or more radio pulses, width of the one or more radio pulses, spacing between adjacent one or more radio pulses, pulse power and background noise or interference power.

In particular embodiments, the bases station comprises two or more receiver antennas and receiving the plurality of radio signal samples comprises receiving the plurality of radio signal samples at the two or more antennas. Estimating parameters for the first and the second hypothesis functions may comprise estimating a spatial parameter vector that characterizes the channel and/or estimating a direction of arrival. The estimated direction of arrival may comprise an elevation angle of arrival. The estimated direction of arrival may be compared to an expected direction of arrival. Estimating parameters for the first and the second hypothesis functions may comprise estimating a vector of spatial combining weights.

In particular embodiments, the method further comprises, upon determining the radio pulse is present, stopping operation of a radio service provided by the base station.

According to some embodiments, a network node comprises a wireless communication interface and processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments derive a decision metric based on a generalized log-likelihood ratio test that aims to minimize the probability of missed detection for any given target probability of false-alarm probability, or equivalently to minimize the probability of false alarm probability for any given target probability of missed detection.

The metric is invariant to any amplification or scaling of the received signal, and thus a fixed decision threshold may be used independently of the amplifier or channel gains. This metric is advantageous for use with a time-varying channel and in cases where the radar is in motion and can shift direction of transmission over time. Some embodiments include estimating the group of parameters that characterize any underlying structure of the radar pulse signal when the radar signal is assumed to be present.

Some embodiments estimate the optimal vector of spatial combining weights that can be applied to received signals from the antennas to maximize the signal-to-noise ratio during the detection. FIG. 1 illustrates the probability of missed detection and the probability of false alarm for randomized chirp radar signal using the decision metric for receivers with multiple antenna and different thresholds. One advantage is the low levels of radar-to-noise ratio (RNR) that the detector can operate on with both low probability of missed detection and low probability of false alarm.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the probability of missed detection and the probability of false alarm for randomized chirp radar signal using the decision metric for receivers with multiple antenna and different thresholds;

FIG. 2 illustrates radar detection using a cellular network of base stations or network nodes as a sensor network;

FIG. 3 is a flow diagram illustrating the process flow for a generalized likelihood ratio test (GLRT) detector;

FIG. 4 is a flow diagram illustrating the process flow for a GLRT detector using multiple antennas;

FIG. 5 is a signal flow diagram illustrating a channel and GLRT detector at a receiver;

FIG. 6 is two graphs illustrating hypothesis testing of radar detection using multiple antennas;

FIG. 7 is two graphs illustrating hypothesis testing of single pulse detection;

FIG. 8 is a flowchart illustrating the procedure for the joint estimation of a parameter set characterizing the radar signal;

FIG. 9 is two graphs illustrating hypothesis testing of multiple pulse detection;

FIG. 10 is a block diagram illustrating an example wireless network;

FIG. 11 illustrates an example user equipment, according to certain embodiments;

FIG. 12 is a flowchart illustrating an example method performed by a network node, according to particular embodiments;

FIG. 13 illustrates a schematic block diagram of a wireless device and network node in a wireless network, according to certain embodiments;

FIG. 14 illustrates an example virtualization environment, according to certain embodiments;

FIG. 15 illustrates an example telecommunication network connected via an intermediate network to a host computer, according to certain embodiments;

FIG. 16 illustrates an example host computer communicating via a base station with a user equipment over a partially wireless connection, according to certain embodiments;

FIG. 17 is a flowchart illustrating a method implemented, according to certain embodiments;

FIG. 18 is a flowchart illustrating a method implemented in a communication system, according to certain embodiments;

FIG. 19 is a flowchart illustrating a method implemented in a communication system, according to certain embodiments; and

FIG. 20 is a flowchart illustrating a method implemented in a communication system, according to certain embodiments.

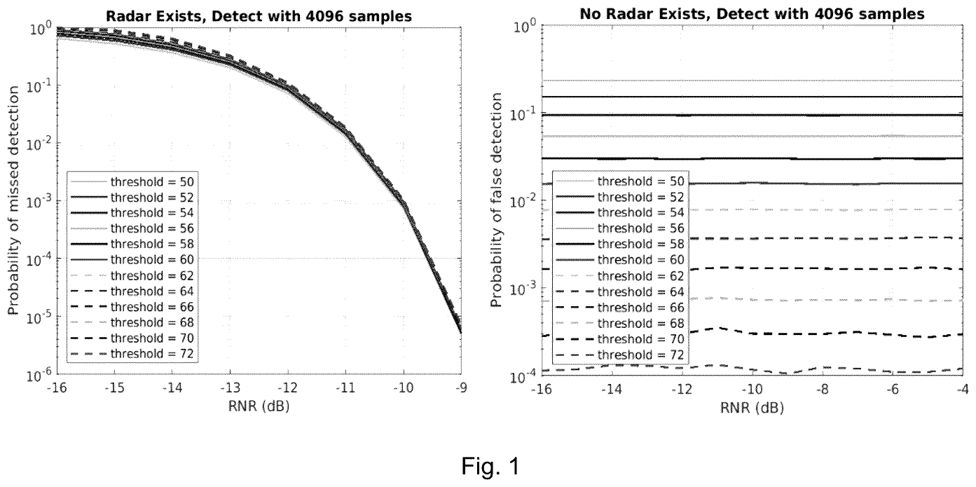

### DETAILED DESCRIPTION

As described above, certain challenges currently exist with detecting pulsed radar signals in wireless networks. Certain aspects of the present disclosure and their embodiments may provide solutions to these or other challenges. Particular embodiments detect the presence of a periodic pulse signal, commonly used in a radar signal (e.g., an airborne radar), over background noise or interference, such as the residual signal obtained by removing an estimated or known signal from the received signal.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

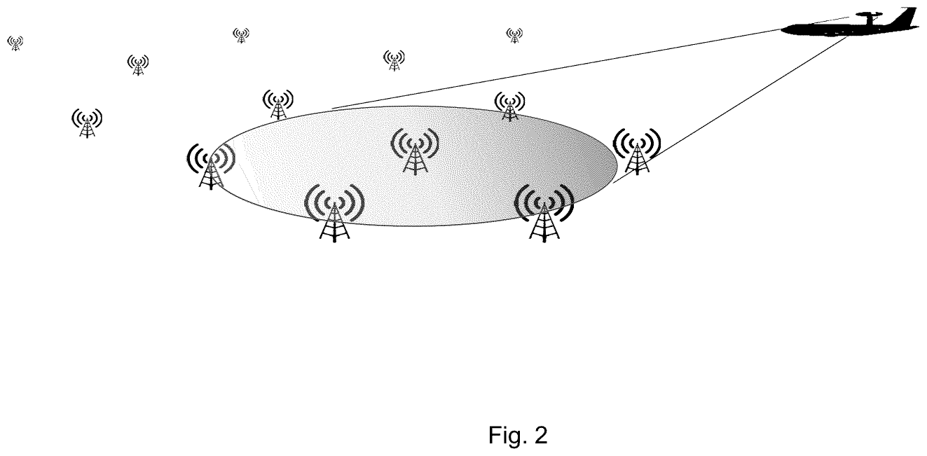

FIG. 2 illustrates radar detection using a cellular network of base stations or network nodes as a sensor network. For example, as the aircraft transmitting radar signals passes over the network nodes, the network nodes may detect the radar signal. The strength of the radar signal with respect to any one base station varies as the aircraft passes overhead.

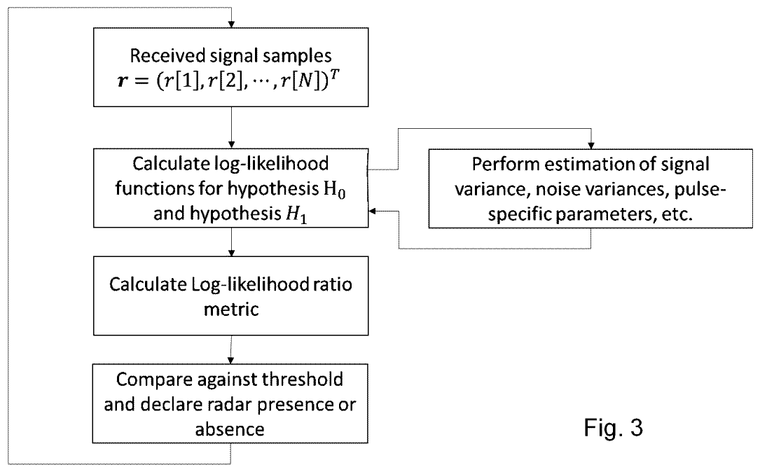

FIG. 3 is a flow diagram illustrating the process flow for a generalized likelihood ratio test (GLRT) detector. In general, the process flow comprises receiving signal samples, calculating log-likelihood functions for a first hypothesis that the received signal samples only contain complex Gaussian distributed background noise and a second hypothesis that the received signal samples include complex Gaussian distributed background noise and one or more radio signal pulses. Particular embodiments estimate parameters such as signal variance, noise variances, pulse-specific parameters, etc. for calculating the log-likelihood functions. After calculating the log-likelihood ratio metric, it is compared against a threshold to determine presence of absence of a radio signal, such as a radar signal. The process is described in more detail below.

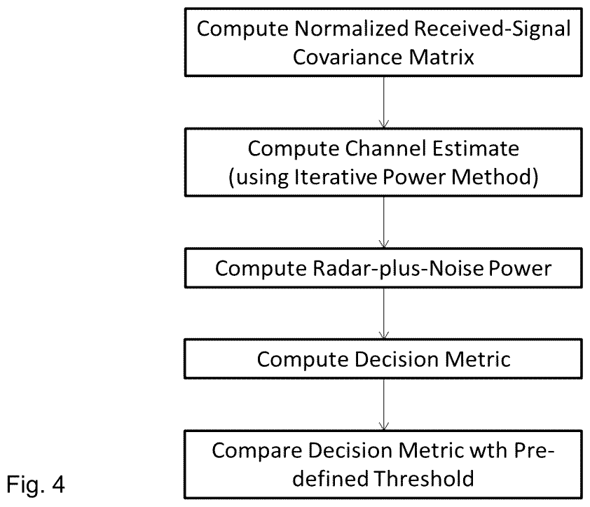

FIG. 4 is a flow diagram illustrating the process flow for a GLRT detector using multiple antennas. In general, the process comprises computing a normalized received signal covariance matrix, computing a channel estimate, computing radar-plus-noise power, computing a decision metric, and comparing the decision metric with a predetermined threshold. The process is described in more detail below.

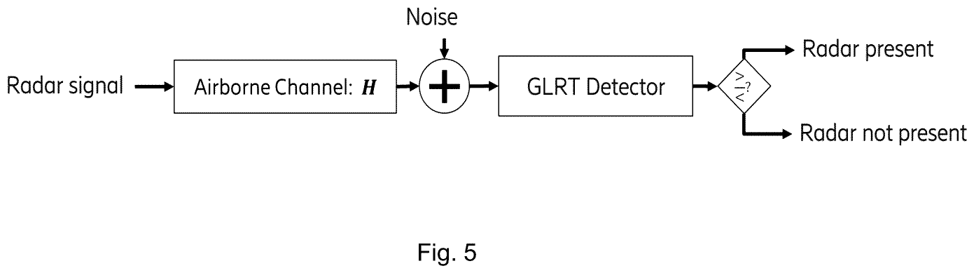

FIG. 5 is a signal flow diagram illustrating a channel and GLRT detector at a receiver. The radar signal is received as channel H which is input to the GLRT detector. The GLRT detector determines where the radar signal is present or not.

As summarized with respect to FIG. 3, particular embodiments include a formulation for hypothesis testing. Let r=(r[1], r[2], . . . , r[N])^{T} be a block of samples of the signal received at a particular cell of a cellular network at a certain sampling frequency. Based on the block of received signal samples, particular embodiments include a detector to determine which of two hypotheses is most likely true.

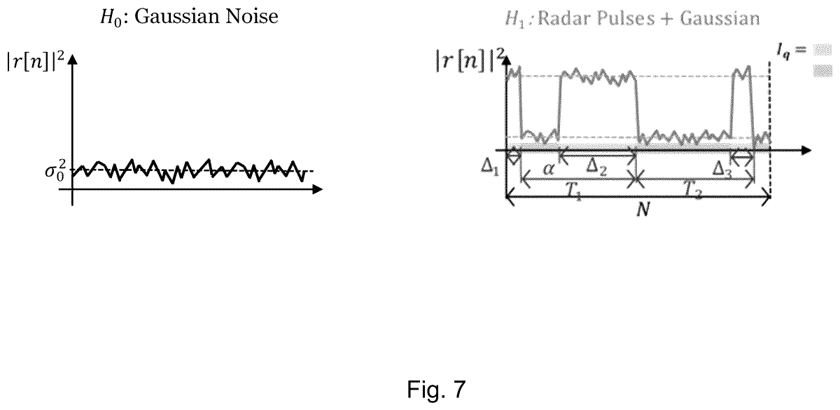

The first hypothesis, referred to as the null hypothesis and labelled by H₀, is that the received signal block only contains complex Gaussian distributed background noise (or residual interference), while the second hypothesis, labelled by H₁, is that the received signal block contains complex Gaussian distributed background noise (or residual interference) plus a train of pulses characterized by a parameter vector q. For example, as illustrated in FIG. 7, the parameter vector q may contain the pulse widths {Δᵢ}, the inter-pulse time periods {Tᵢ}, and the start time a of one of the pulses, i.e. q=(α, Δ₁, Δ₂, Δ₃, . . . , T₁, T₂, . . . ).

More precisely, let I_{q} denote the set of indices of the time when a radar pulse is present, as shown in FIG. 7.

$$Hypothesis {H}_{0} :$$

$$r [ n ] = {w}_{0} [ n ] ∼ C N ( 0 , {σ}_{0}^{2} ) for n = 1 , 2 , … , N$$

$$Hypothesis {H}_{1} :$$

$$r [ n ] = \{ \begin{matrix}w [ n ] & for n ∈ {I}_{q} \\ {w}_{1} [ n ] & for n ∉ {I}_{q}\end{matrix}$$

where w[n]˜CN(0,σ²), w₁[n]˜CN(0,σ₁²), and σ²>σ₁².

Note that CN(0,σ²) denotes complex Gaussian distribution with zero mean and variance σ². Equivalently, the radar signal is modeled as an independent identically distributed (IID) complex Gaussian distributed random process with variance σ²−σ₁², which is positive by definition. Modeling the radar signal as an IID complex Gaussian distributed random process imposes the least amount of assumption on the underlying radar signal, which can lead to the most robust detector regardless of the radar signal.

Note that w₀[n] and w₁[n] are referred to as background noise. In practical systems, there may be a sequence of pre-processing steps performed in the receiver towards obtaining the received signal {r[n]}. For example, {r[n]} may represent the residual signal obtained by subtracting a known signal (e.g., a re-encoded signal, a re-modulated signal, or a pilot signal) from a raw received signal. In this case, the background noise may contain residual interference caused by an imperfectly subtracted known signal. While the radar signal is modeled as a Gaussian signal adding residual energy to the background noise, this is a choice driven by an intention to limit the number of parameters that must be assumed. Indeed, pulsed waveforms transmitted by radar signals are often designed to have time frequency characteristics that can allow for activities such as doppler estimation; signals may, for example, have chirp waveforms. When necessary, particular embodiments are capable of modeling such parameters as well.

Particular embodiments include log likelihood functions. For hypothesis H₀, the log likelihood function is given by

$$log p ( r \vert {σ}_{0} ) = - {\sum }_{n = 1}^{N} \frac{{\vert r [ n ] \vert}^{2}}{{σ}_{0}^{2}} - N log {πσ}_{0}^{2} \qquad ( 1 )$$

For hypothesis H₁, the log likelihood function is given by

$$log p ( r \vert σ , {σ}_{1} , q ) = - {\sum }_{n ∈ {I}_{q}} \frac{{\vert r [ n ] \vert}^{2}}{{σ}^{2}} - {\sum }_{n ∉ {I}_{q}} \frac{{\vert r [ n ] \vert}^{2}}{{σ}_{1}^{2}} - \vert {I}_{q} \vert log {πσ}^{2} - ( N - \vert {I}_{q} \vert ) log {πσ}_{1}^{2} \qquad ( 2 )$$

where |I_{q}| denotes the size of the set I_{q}. Note that due to the on-off nature of the model of the pulses, the contributing terms in the log likelihood function under hypothesis H₀ can be divided into terms that correspond to the time duration I_{q} when pulse signal is on and those that correspond to time duration I_{q}^{c} when pulse signal is off.

Particular embodiments include a log likelihood ratio test. It is known from Neyman-Pearson lemma that the best tradeoff between the minimization of the probability of missed detection and that of the probability of false alarm can be achieved by the log-likelihood ratio test (LLRT). The metric for such a test can be expressed as:

$$Metric ( {σ}_{0} , {σ}_{1} , σ , q ) = log p ( r \vert σ , {σ}_{1} , q ) - log p ( r \vert {σ}_{0} ) \qquad ( 3 )$$

However, the various parameters under respective hypotheses are typically unknown and need to be estimated. Using the maximum likelihood estimates of these parameters, particular embodiments arrive at a generalized log-likelihood ratio test (GLRT). The metric for such a test can be expressed as:

$$Metric = {max}_{σ , {σ}_{1} , q} log p ( r \vert σ , {σ}_{1} , q ) - {max}_{{σ}_{0}} log p ( r \vert {σ}_{0} ) . \qquad ( 4 )$$

The test is performed by comparing the metric with a certain predetermined threshold, Y, whose value may depend on the largest tolerable probability of false alarm during the system design. Because Hypothesis H₀ can be viewed as a special case of Hypothesis H₁, the GLRT decision metric is always nonnegative, and thus the threshold is always positive.

Before a radar signal is detected, the presence of a radar signal is declared by the cellular network when the metric is larger than a first threshold. Conversely, after a radar signal is detected, the absence of the radar signal is declared by the cellular network when the metric is smaller than a second threshold, which may be different from the first threshold.

Particular embodiments include maximum-likelihood parameter estimation. Under each hypothesis, there are unknown parameters that need to be estimated.

Under hypothesis H₀, the maximum-likelihood (ML) estimate of the power or variance of the background noise is given by

$${\hat{σ}}_{0}^{2} {=}^{Δ} {arg max}_{{σ}_{0}} log p ( r \vert {σ}_{0} ) = \frac{{‖ r ‖}^{2}}{N} = \frac{1}{N} {\sum }_{n = 1}^{N} {\vert r [ n ] \vert}^{2} . \qquad ( 5 )$$

Substituting it into (1) obtains

$$log p ( r \vert {\hat{σ}}_{0} ) = {max}_{{σ}_{0}} log p ( r \vert {σ}_{0} ) = - N log πe - N log \frac{{\sum }_{n = 1}^{N} {\vert r [ n ] \vert}^{2}}{N} \qquad ( 6 )$$

Under Hypothesis H₁, for a given group of pulse-specific parameters q, the time duration I_{q} is determined. With the given I_{q}, the ML estimate of pulse power σ² and noise power σ₁² are, respectively,

$${\hat{σ}}^{2} {=}^{Δ} {arg max}_{σ} log p ( r \vert σ , {σ}_{1} , q ) = \frac{1}{\vert {I}_{q} \vert} {\sum }_{n ∈ {I}_{q}} {\vert r [ n ] \vert}^{2} \qquad ( 7 )$$

$${\hat{σ}}_{1}^{2} {=}^{Δ} {arg max}_{{σ}_{1}} log p ( r \vert σ , {σ}_{1} , q ) = \frac{1}{N - \vert {I}_{q} \vert} {\sum }_{n ∉ {I}_{q}} {\vert r [ n ] \vert}^{2} \qquad ( 8 )$$

Note that \hat{σ}² and \hat{σ}₁² are both functions of the parameter set q.

Substituting (7) and (8) into (2) obtains

$$log p ( r \vert \hat{σ} , {\hat{σ}}_{1} , q ) = {max}_{σ , {σ}_{1}} log p ( r \vert σ , {σ}_{1} , q ) = - N log πe - \vert {I}_{q} \vert log \frac{{\sum }_{n ∈ {I}_{q}} {\vert r [ n ] \vert}^{2}}{\vert {I}_{q} \vert} - ( N - \vert {I}_{q} \vert ) log \frac{{\sum }_{n ∉ {I}_{q}} {\vert r [ n ] \vert}^{2}}{N - \vert {I}_{q} \vert} \qquad ( 9 )$$

where |I_{q}| denotes the total number of time samples (which indicates the total time duration) when the pulsed signal is within the block of received signal samples. Let Ω_{q} denote a set of possible settings or configurations for the group of pulsed-specific parameters q. The ML estimate of pulse specific parameters q is then

$$\hat{q} {=}^{Δ} {arg max}_{q ∈ {Ω}_{q}} log p ( r \vert \hat{σ} , {\hat{σ}}_{1} , q ) = {arg min}_{q ∈ {Ω}_{q}} \{ \vert {I}_{q} \vert log \frac{{\sum }_{n ∈ {I}_{q}} {\vert r [ n ] \vert}^{2}}{\vert {I}_{q} \vert} + ( N - \vert {I}_{q} \vert ) log \frac{{\sum }_{n ∉ {I}_{q}} {\vert r [ n ] \vert}^{2}}{N - \vert {I}_{q} \vert} \} \qquad ( 10 )$$

Combining (6), (9), and (4) obtains an optimal metric as given by GLRT from any pulse specific parameters:

$$Metric = N log \frac{{\sum }_{n = 1}^{N} {\vert r [ n ] \vert}^{2}}{N} - {min}_{q ∈ {Ω}_{q}} \{ \vert {I}_{q} \vert log \frac{{\sum }_{n ∈ {I}_{q}} {\vert r [ n ] \vert}^{2}}{\vert {I}_{q} \vert} + ( N - \vert {I}_{q} \vert ) log \frac{{\sum }_{n ∉ {I}_{q}} {\vert r [ n ] \vert}^{2}}{N - \vert {I}_{q} \vert} \} \qquad ( 11 )$$

Note that according to (11), for a given pulse-ON time duration |I_{q}|, I_{q} should be chosen such that it contains the largest energy Eₒₙ≙Σ_{n∈I}_{_{q}}|r[n]|².

Particular embodiments include a detection algorithm for general on-off pulsed signal. Described below is a sequence of steps of a proposed detection algorithm based on (11).
1. For each candidate pulse-specific parameter setting q∈Ω_{q}, compute total energy when pulsed signal is both on and off,

$${E}_{o n} = {\sum }_{n ∈ {I}_{q}} {\vert r [ n ] \vert}^{2} and {E}_{off} = {\sum }_{n ∉ {I}_{q}} {\vert r [ n ] \vert}^{2}$$

2. For each candidate pulse-specific parameter setting q∈Ω_{q}, compute negative log likelihood (of Hypothesis H₁),

$$N L L ( q ) = \vert {I}_{q} \vert log \frac{{\sum }_{n ∈ {I}_{q}} {\vert r [ n ] \vert}^{2}}{\vert {I}_{q} \vert} + ( N - \vert {I}_{q} \vert ) log \frac{{\sum }_{n ∉ {I}_{q}} {\vert r [ n ] \vert}^{2}}{N - \vert {I}_{q} \vert}$$

3. Find the best pulse-specific parameter setting:

$$\hat{q} = {arg min}_{q} NLL ( q )$$

where NNL(q) denotes the negative log likelihood function under Hypothesis H₁.
4. Compute decision metric:

$$Metric = N log \frac{{\sum }_{n = 1}^{N} {\vert r [ n ] \vert}^{2}}{N} - NLL ( \hat{q} )$$

5. Declare detection of radar pulse if

Metric>γ

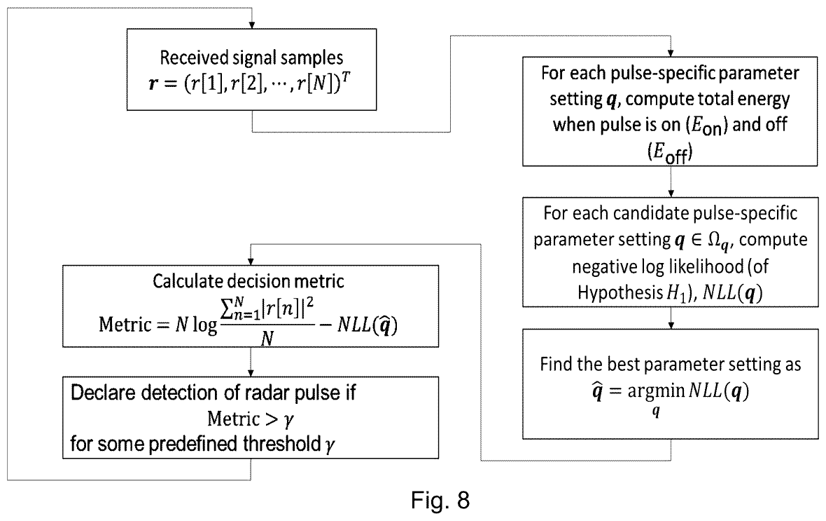

for some predefined threshold y. An example is illustrated in FIG. 8.

FIG. 8 is a flowchart illustrating the procedure for the joint estimation of a parameter set characterizing the radar signal.

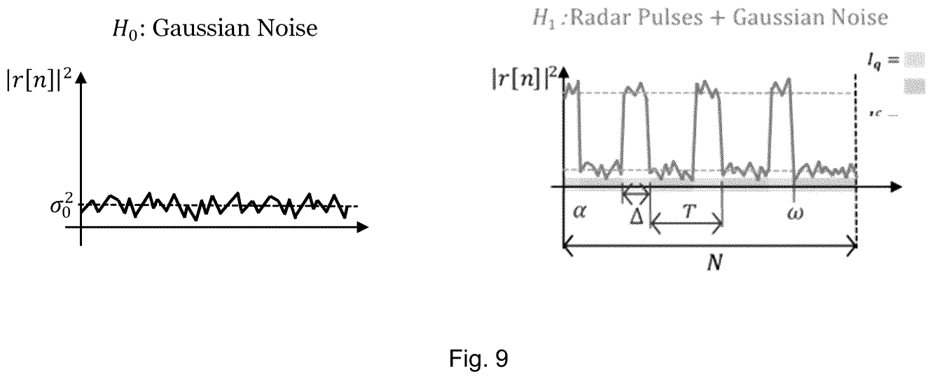

Some embodiments include a method of detection of multiple pulses. One example considers the detection of a particular example of pulses: a train of multiple pulses of the same width, as illustrated in FIG. 9. In this example, the parameter vector q may contain the first pulse fall time α within the received signal block, the last pulse fall time ω, inter-pulse period T, and the pulse width Δ. In other words, q=(α, Δ, T, ω) and I_{q} becomes I_{α,Δ,T,ω}.

Described below is a sequence of steps of an example detection algorithm for multiple pulses. Let Ω_{α}, Ω_{Δ}, Ω_{T}, Ω_{ω} be the set of possible values for the first pulse fall time α within the received signal block, the last pulse fall time w, inter-pulse period T, and the pulse width Δ, respectively.
1. For each candidate α∈Ω_{α}, Δ∈Ω_{Δ}, T∈Ω_{T}, and ω∈Ω_{ω}, compute total energy when pulsed signal is both on and off,

$${E}_{on} = {\sum }_{n ∈ {I}_{α , Δ , T , ω}} {\vert r [ n ] \vert}^{2} and {E}_{off} = {\sum }_{n ∉ {I}_{α , Δ , T , ω}} {\vert r [ n ] \vert}^{2} \\ where {I}_{α , Δ , T , ω} = \{ n : \}$$

2. For each candidate pulse-specific parameter setting q∈Ω_{q}, compute negative log likelihood (of Hypothesis H₁),

$$NLL ( α , Δ , T , ω ) = \vert {I}_{α , Δ , T , ω} \vert log \frac{{\sum }_{n ∈ {I}_{α , Δ , T , ω}} {\vert r [ n ] \vert}^{2}}{\vert {I}_{α , Δ , T , ω} \vert} + ( N - \vert {I}_{α , Δ , T , ω} \vert ) log \frac{{\sum }_{n ∉ {I}_{α , Δ , T , ω}} {\vert r [ n ] \vert}^{2}}{N - \vert {I}_{α , Δ , T , ω} \vert}$$

3. Find the best pulse-specific parameter setting:

$$( \hat{α} , \hat{Δ} , \hat{T} , \hat{ω} ) = {arg min}_{α , Δ , T , ω} NLL ( α , Δ , T , ω )$$

where NNL (α, Δ, T, ω) denotes the negative log likelihood function under Hypothesis H₁.
4. Compute decision metric:

$$Metric = N log \frac{{\sum }_{n = 1}^{N} {\vert r [ n ] \vert}^{2}}{N} - NLL ( \hat{α} , \hat{Δ} , \hat{T} , \hat{ω} )$$

5. Declare detection of radar pulse if

Metric>γ

for some predefined threshold y

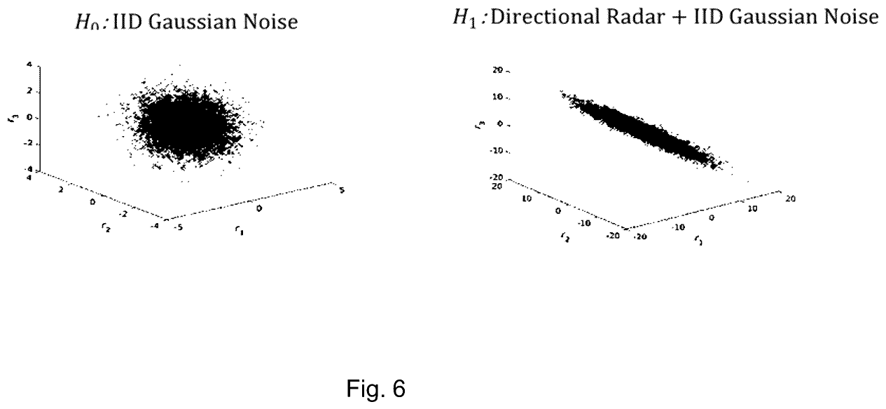

FIG. 6 is two graphs illustrating hypothesis testing of radar detection using multiple antennas. The graph on the left illustrates IID Gaussian noise and the graph on the right illustrates a directional radar signal plus IID Gaussian noise.

Particular embodiments include detection of a pulse signal using multiple antennas. The detection includes a formulation for hypothesis testing. Let r[n]=(r₁[n], r₂[n], . . . , r_{K}[n])^{T} be a signal vector received by an antenna array with K antenna elements at a particular cell, where rᵢ[n] denotes the signal received by antenna i. Let r=(r[1]^{T}, r[2]^{T}, . . . , r[N]^{T})^{T} be a block of signal vectors received at a particular cell of a cellular network using the antenna array at a certain sampling frequency. Based on the block of received signal vectors, particular embodiments include a detector to determine which of the two hypotheses is most likely be true (summarized in FIG. 4).

The first hypothesis, referred to as the null hypothesis and labelled by H₀, is that the received signal block only contains IID complex Gaussian distributed background noise (or residual interference), while the second hypothesis, labelled by H₁, is that the received signal block contains complex Gaussian distributed background noise (or residual interference) plus a scalar pulse signal transmitted through a single-input multiple-output (SIMO) channel with channel response h to the receiver. The scalar pulse signal is modeled as a scalar IID complex Gaussian distributed random process with zero mean and variance or power P. The channel response h implicitly specifies the direction of arrival at the receiver. This channel response h also determines the proper spatial combining weights to be applied to the antenna elements in the antenna panel to maximize the SNR towards the direction of arrival. For this reason, h is referred to as the channel response or the spatial combining weight vector.

$$Hypothesis {H}_{0} : r [ n ] = {w}_{0} [ n ] ∼ CN ( 0 , {σ}_{0}^{2} I ) , for n = 1 , 2 , … , N \\ Hypothesis {H}_{1} : r [ n ] = hw [ n ] + {w}_{1} [ n ] , for n = 1 , 2 , … , N \\ where w [ n ] ∼ CN ( 0 , P ) , {w}_{1} [ n ] ∼ C N ( 0 , {σ}_{1}^{2} I ) , ‖ h ‖ = 1 and P > 0 .$$

Note that r[n], for each n, is a IID complex Gaussian distributed vector with covariance matrix Phh^{H}+σ₁², i.e. r[n]˜CN(0, Phh^{H}+σ₁²I).

Note that CN(0,σ²) denotes a complex Gaussian distribution with zero mean and variance σ², and CN(0,σ₁²I) denotes a complex Gaussian multivariate distribution with zero mean and covariance matrix σ²I. Equivalently, the radar signal may be modelled as a scalar IID complex Gaussian distributed random process {w[n]} with zero mean and variance P. Modeling the radar signal as a scalar IID complex Gaussian distributed random process imposes the least amount of assumption on the underlying radar signal, which can lead to the most robust detector regardless of the radar signal.

Note that although w₀[n] and w₁[n] are referred to as background noise, in practical systems there may be a sequence of pre-processing steps performed in the receiver to obtain the received signal {r[n]}. For example, {r[n]} may represent the residual signal obtained by subtracting a known signal (e.g., a re-encoded signal, a re-modulated signal, or a pilot signal) from a raw received signal. In this case, the background noise may contain the residual interference caused by imperfectly subtracted known signal.

Particular embodiments include log likelihood functions. For hypothesis H₀, the log likelihood function is given by

$$log p ( r \vert {σ}_{0} ) = - {\sum }_{n = 1}^{N} \frac{{‖ r [ n ] ‖}^{2}}{{σ}_{0}^{2}} - NK log {πσ}_{0}^{2} \qquad ( 12 )$$

For hypothesis H₁, the log likelihood function is given by

$$log p ( r \vert P , {σ}_{1} , h ) = \text{} - \frac{{h}^{H} {Φ}_{r} h}{P + {σ}_{1}^{2}} - \frac{{Σ}_{n = 1}^{N} {‖ r [ n ] ‖}^{2} - {h}^{H} {Φ}_{r} h}{{σ}_{1}^{2}} - N log π ( P + {σ}_{1}^{2} ) - N ( K - 1 ) log π {σ}_{1}^{2} \qquad ( 13 )$$

where Φᵣ≙Σₙ₌₁^{N}r[n]r[n]^{H} is the covariance matrix of the received vectorized signal r[n]. Note that due to the on-off nature of the model of the pulses, the contributing terms in the log likelihood function under hypothesis H₀ can be divided into terms in the log likelihood function under Hypothesis H₁ that correspond to the channel response h along with its associated direction of arrival and those terms that correspond all channel responses or directions of arrivals other than those of v.

Particular embodiments include a log likelihood ratio test. It is known from Neyman-Pearson lemma that the best tradeoff between the minimization of the probability of missed detection and that of the probability of false alarm can be achieved by the log-likelihood ratio test (LLRT). The metric for such a test can be expressed as:

$$Metric ( {σ}_{0} , {σ}_{1} , P , h ) = log p ( r \vert P , {σ}_{1} , h ) - log p ( r \vert {σ}_{0} ) . \qquad ( 14 )$$

However, the various parameters under respective hypotheses are typically unknown and need to be estimated. Using the maximum likelihood estimates of these parameters, one arrives at a generalized log-likelihood ratio test (GLRT). The metric for such a test can be expressed as:

$$Metric = {max}_{σ , P , h} log p ( r \vert P , {σ}_{1} , h ) - {max}_{{σ}_{0}} log p ( r \vert {σ}_{0} ) . \qquad ( 15 )$$

The test is performed by comparing this metric with a certain predetermined threshold, y, whose value may depend on the largest tolerable probability of false alarm during the system design. Because Hypothesis H₀ can be viewed as a special case of Hypothesis H₁, the GLRT decision metric is always nonnegative, and thus the threshold must always be positive.

Before a radar signal is detected, the presence of a radar signal is declared by the cellular network when the metric is larger than a first threshold. Conversely, after a radar signal is detected, the absence of the radar signal is declared by the cellular network when the metric is smaller than a second threshold, which may be different from the first threshold.

Particular embodiments include maximum-likelihood parameter estimation. Under each hypothesis, there are unknown parameters that need to be estimated.

Under hypothesis H₀, the maximum-likelihood (ML) estimate of the power or variance of the background noise is given by

$${\hat{σ}}_{0}^{2} {=}^{Δ} {arg min}_{{σ}_{0}} log p ( r \vert {σ}_{0} ) {=}^{Δ} \frac{{‖ r ‖}^{2}}{NK} = \frac{1}{NK} {\sum }_{n = 1}^{N} {‖ r [ n ] ‖}^{2} = \frac{1}{NK} {\sum }_{n = 1}^{N} {\sum }_{k = 1}^{K} {\vert {r}_{k} [ n ] \vert}^{2} \qquad ( 16 )$$

Substituting it into (12) obtains

$$log p ( r \vert {\hat{σ}}_{0} ) = - NK log π e - NK log \frac{{Σ}_{n = 1}^{N} {‖ r [ n ] ‖}^{2}}{NK} \qquad ( 17 )$$

Under Hypothesis H₁, for a given channel response h, the ML estimate of radar power P and noise power of σ₁² are, respectively,

$$\hat{P} {=}^{Δ} {arg max}_{P} \{ {max}_{{σ}_{1}} log p ( r \vert P , {σ}_{1} , h ) \} = \frac{1}{N ( K - 1 )} ( {Kh}^{H} {Φ}_{r} h - {\sum }_{n = 1}^{N} {‖ r [ n ] ‖}^{2} ) \qquad ( 18 )$$

$${\hat{σ}}_{1}^{2} {=}^{Δ} {arg min}_{{σ}_{1}} \{ {max}_{P} log p ( r \vert P , {σ}_{1} , h ) \} = \frac{1}{N ( K - 1 )} ( {\sum }_{n = 1}^{N} {‖ r [ n ] ‖}^{2} - {h}^{H} {Φ}_{r} h ) \qquad ( 19 )$$

Substituting (18) and (19) into (13) gives

$$log p ( r \vert \hat{P} , {\hat{σ}}_{1} , h ) = - NK log π e - N log \frac{1}{N} {h}^{H} {Φ}_{r} h - N ( K - 1 ) log \frac{1}{N ( K - 1 )} ( {\sum }_{n = 1}^{N} {‖ r [ n ] ‖}^{2} - {h}^{H} {Φ}_{r} h ) . \qquad ( 20 )$$

It can be shown that log p(r|\hat{P}, \hat{σ}₁, h) is a monotonically non-decreasing function of the quantity h^{H}Φᵣh when h^{H}Φᵣh is larger than the average amount of energy in the received vector signal per antenna, i.e. tr{Φᵣ}/K. Thus, maximizing the log likelihood function is the same as maximizing h^{H}Φᵣh. That is,

$$\hat{h} {=}^{Δ} {arg max}_{h} log p ( r \vert \hat{P} , {\hat{σ}}_{1} , h ) = {arg max}_{h : ‖ h ‖ = 1} {h}^{H} {Φ}_{r} h . \qquad ( 21 )$$

In other words, maximum likelihood estimate ĥ is the principal eigenvector of Φᵣ=Σₙ₌₁^{N}r[n]r[n]^{H} that corresponds to the maximum eigenvalue

$${λ}_{max} ( {Φ}_{r} ) {=}^{Δ} {max}_{h : ‖ h ‖ = 1} {h}^{H} {Φ}_{r} h$$

of the received signal covariance matrix Φᵣ.

Combining (17), (20), and (15) obtains an optimal metric as given by GLRT for any receivers with multiple antennas:

$$Metric = NK log \frac{1}{N K} {\sum }_{n = 1}^{N} {‖ r [ n ] ‖}^{2} - N log \frac{{λ}_{max} ( {Φ}_{r} )}{N} - N ( K - 1 ) log \frac{1}{N ( K - 1 )} ( {\sum }_{n = 1}^{N} {‖ r [ n ] ‖}^{2} - {λ}_{max} ( {Φ}_{r} ) ) \qquad ( 22 )$$

It can be shown that this metric must always be non-negative, and thus the threshold must be positive. Also, the threshold is independent of any scaling of the received signal, and thus the same threshold can be used for any received signal amplifier gains.

Note that λₘₐₓ(Φᵣ) is the power of spatially combined received signal, and ĥ^{H} is the spatial combining weights that corresponds to the channel estimate ĥ. The spatial combining weights are used for the receiver to combine the signals from all antennas into a single scalar signal as shown below:

$${λ}_{max} ( {Φ}_{r} ) = {\hat{h}}^{H} {Φ}_{r} \hat{h} = {\hat{h}}^{H} [ {\sum }_{n = 1}^{N} r [ n ] {r [ n ]}^{H} ] \hat{h} = {\sum }_{n = 1}^{N} {\vert {\hat{h}}^{H} r [ n ] \vert}^{2}$$

The task of finding the principal eigenvector of Φᵣ is essentially finding the best spatial combining weights for combining signals from multiple antennas at a receiver for detection decision.

It is well known that the principal eigenvector of a matrix can be computed using an iterative power method. That is, beginning with an arbitrary non-zero initial channel estimate ĥ⁽⁰⁾, one can compute

$${\hat{h}}^{( m + 1 )} = \frac{{Φ}_{r} {\hat{h}}^{( m )}}{‖ {Φ}_{r} {\hat{h}}^{( m )} ‖} \qquad ( 23 )$$

recursively and increment the iteration index m after each computation of (23). As the number of iteration index m increases, ĥ^{(m)} will converge to the desired principal eigenvector of Φᵣ.

Described below is a sequence of steps of a detection algorithm based on (22). The algorithm is also summarized in FIG. 4. For notational simplicity, the example normalizes (and redefines) the received signal covariance matrix Φᵣ, i.e. replacing Φᵣ by 1/NΦᵣ and make corresponding adjustments on (22).

### Radar Detection Algorithm for Multi-Antenna Receivers

1. Compute the normalized received-signal covariance matrix:

$${Φ}_{r} = \frac{1}{N} {\sum }_{n = 1}^{N} r [ n ] {r [ n ]}^{H}$$

2. Compute channel estimate using iterative power method:

$${\hat{h}}^{( m + 1 )} = \frac{{Φ}_{r} {\hat{h}}^{( m )}}{‖ {Φ}_{r} {\hat{h}}^{( m )} ‖} \to \hat{h}$$

with the initial non-zero estimate ĥ⁽⁰⁾ chosen arbitrarily, where m is an iteration index.
3. Compute Radar-plus-Noise Power:

$${λ}_{max} {=}^{Δ} {\hat{h}}^{H} {Φ}_{r} \hat{h}$$

4. Compute Decision Metric:

$$Metric = NK log \frac{t r ( {Φ}_{r} )}{K} - N log {λ}_{max} - N ( K - 1 ) log \frac{t r ( {Φ}_{r} ) - {λ}_{max}}{K - 1}$$

5. Declare detection of radar pulse if, for some predefined threshold γ,

Metric>γ

Some embodiments impose elevation constraints in channel estimation. For airborne radar, the radar transmitter is on a plane that is located above the horizon. In this case, the channel estimate ĥ can be forced to map to direction above horizon to reduce the detection complexity and the number of estimated parameters. For example, one can restrict the channel estimate ĥ to come from the linear combinations of columns of a predefined constraint matrix D, whose columns define the span of the admissible directions for ĥ. In other words, define ĥ(c)=Dc and compute

$${λ}_{max} {=}^{Δ} {max}_{c ∈ 𝒞} {h ( c )}^{H} {Φ}_{r} h ( c ) = {max}_{c ∈ 𝒞} {c}^{H} [ {D}^{H} {Φ}_{r} D ] c$$

where C denotes the set of admissible combining vector c that is used to scale and combine the columns of the matrix D. In practice, the constraint matrix D is a tall matrix, i.e. has more rows than columns, so that the dimension of the combining vector c is smaller than the channel estimate h. For example, the constraint matrix D may be a submatrix of an FFT matrix, whose columns correspond to directions of arrival above the horizon.

Some embodiments include imposing constraint based on rectangular antenna arrays. The antenna panel of a base station (or gNB in 5G NR) typically has a rectangular structure, which translates into a Kronecker product constraint on the channel h:

$$h = {h}_{a z} ⊗ {h}_{ev} , \qquad ( 24 )$$

where h_{az} and hₑᵥ are the azimuth and elevation components of the channel estimate h, ‘az’ is short for azimuth, and ‘ev’ is short for elevation.

In other words, some relationships can be imposed between the coefficients in the channel h due to the rectangular structure of the antenna panel. Specifically, [h]ᵢₖ_{ₑᵥ}₊ⱼ=[h_{az}]ᵢ[hₑᵥ]ⱼ for i=0, 1, . . . , K_{az}, j=0, 1, . . . , Kₑᵥ, where h_{az}∈C^{K}^{_{az}}, hₑᵥ∈C^{K}^{ₑᵥ}, K=K_{az}Kₑᵥ. Note that the dimensions of h_{az} and hₑᵥ are much smaller than h, and thus there are fewer total number of parameters to estimate. The performance can thus be improved, and the computational complexity can be reduced accordingly.

The Kronecker product structure can be used in the maximum eigenvalue computation by expressing h^{H}Φᵣh as

$${h}^{H} {Φ}_{r} h = {\sum }_{{k}_{1} = 0}^{K - 1} {\sum }_{{k}_{2} = 0}^{K - 1} {{{[ h ]}_{{k}_{1}}^{*} [ {Φ}_{r} ]}_{{k}_{1} , {k}_{2}} [ h ]}_{{k}_{2}} = {\sum }_{{i}_{1} = 0}^{{K}_{a z}} {\sum }_{{j}_{1} = 0}^{{K}_{e v}} {\sum }_{{i}_{2} = 0}^{{K}_{a z}} {\sum }_{{j}_{2} = 0}^{{K}_{e v}} {{{{{[ {h}_{a z} ]}_{{i}_{1}}^{*} [ {h}_{e v} ]}_{{j}_{1}}^{*} [ {Φ}_{r} ]}_{{i}_{1} {K}_{e v} + {j}_{1} , {i}_{2} {K}_{e v} + {j}_{2}} [ {h}_{a z} ]}_{{i}_{2}} [ {h}_{e v} ]}_{{j}_{2}} = {h}_{a z}^{H} {Φ}_{r \vert {h}_{e v}}^{a z} {h}_{a z} = {h}_{e v}^{H} {Φ}_{r \vert {h}_{a z}}^{e v} {h}_{e v} \qquad ( 25 )$$

$$where$$

$${[ {Φ}_{r \vert {h}_{e v}}^{a z} ]}_{{i}_{1} , {i}_{2}} {=}^{Δ} {\sum }_{{j}_{1} = 0}^{{K}_{e v} - 1} {\sum }_{{j}_{2} = 0}^{{K}_{e v} - 1} {{{[ {h}_{e v} ]}_{{j}_{1}}^{*} [ {Φ}_{r} ]}_{{i}_{1} {K}_{e v} + {j}_{1} , {i}_{2} {K}_{e v} + {j}_{2}} [ {h}_{e v} ]}_{{j}_{2}}$$

$$and$$

$${[ {Φ}_{r \vert {h}_{a z}}^{e v} ]}_{{j}_{1} , {j}_{2}} {=}^{Δ} {\sum }_{{i}_{1} = 0}^{{K}_{a z} - 1} {\sum }_{{i}_{2} = 0}^{{K}_{a z} - 1} {{{[ {h}_{a z} ]}_{{i}_{1}}^{*} [ {Φ}_{r} ]}_{{i}_{1} {K}_{e v} + {j}_{1} , {i}_{2} {K}_{e v} + {j}_{2}} [ {h}_{a z} ]}_{{i}_{2}} .$$

Based on (25), h_{az} and hₑᵥ can be computed iteratively by computing one while holding the other fixed. More precisely, they can be computed using the following algorithm.

Iterative algorithm for computing principal eigenvector as channel estimate for rectangular antenna arrays:
1. Initialization: Set m=0, h_{az}⁽⁰⁾=[1, . . . , 1]^{T} and hₑᵥ=[1, . . . , 1]^{T}
2. Search for best elevation component of channel:

$${\hat{h}}_{e v}^{( m + 1 )} = {arg max}_{h : \vert \vert h ‖ = 1} {h}^{H} {Φ}_{r \vert {h}_{a z}^{( m )}}^{e v} h$$

$$where$$

$${[ {Φ}_{r \vert {h}_{a z}}^{e v} ]}_{{j}_{1} , {j}_{2}} {=}^{Δ} {\sum }_{{i}_{1} = 0}^{{K}_{a z} - 1} {{{{\sum }_{{i}_{2} = 0}^{{K}_{a z} - 1} [ {h}_{a z} ]}_{{i}_{1}}^{*} [ {Φ}_{r} ]}_{{i}_{1} {K}_{e v} + {j}_{1} , {i}_{2} {K}_{e v} + {j}_{2}} [ {h}_{a z} ]}_{{i}_{2}}$$

3. Search for best azimuth component of channel:

$${\hat{h}}_{a z}^{( m + 1 )} = {arg max}_{h : \vert \vert h ‖ = 1} {h}^{H} {Φ}_{r \vert {h}_{e v}^{( m )}}^{a z} h$$

$$where$$

$${[ {Φ}_{r \vert {h}_{e v}}^{a z} ]}_{{i}_{1} , {i}_{2}} {=}^{Δ} {\sum }_{{j}_{1} = 0}^{{K}_{e v} - 1} {{{{\sum }_{{j}_{2} = 0}^{{K}_{e v} - 1} [ {h}_{e v} ]}_{{j}_{1}}^{*} [ {Φ}_{r} ]}_{{i}_{1} {K}_{e v} + {j}_{1} , {i}_{2} {K}_{e v} + {j}_{2}} [ {h}_{e v} ]}_{{j}_{2}}$$

4. Set m+1→m and go back to Step 2 until termination condition is satisfied
5. Compute principal eigenvector: ĥ=ĥ_{az}⊗ĥₑᵥ.

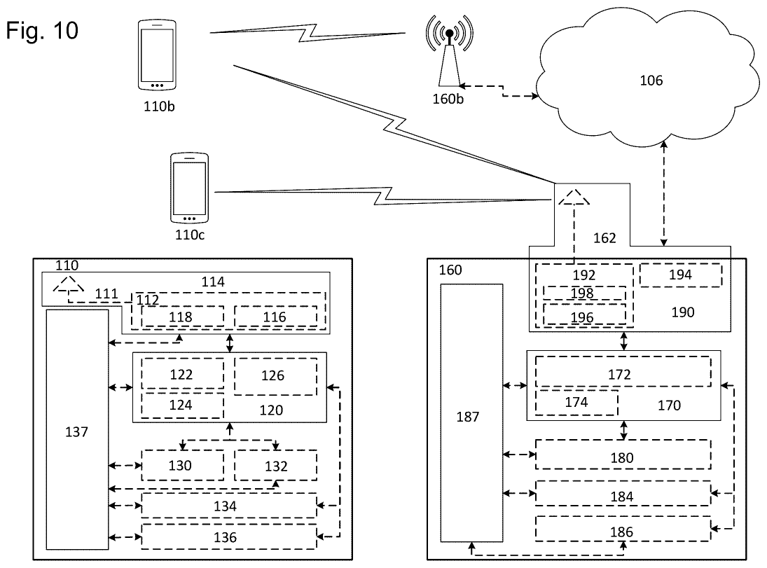

FIG. 10 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node 160 includes processing circuitry 170, device readable medium 180, interface 190, auxiliary equipment 184, power source 186, power circuitry 187, and antenna 162. Although network node 160 illustrated in the example wireless network of FIG. 10 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, cither alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 10 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g., refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

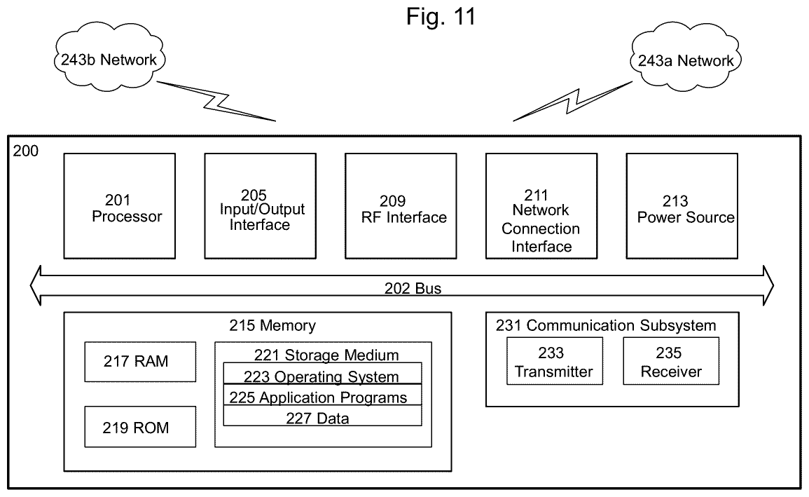

FIG. 11 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 11, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may use all the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 11, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

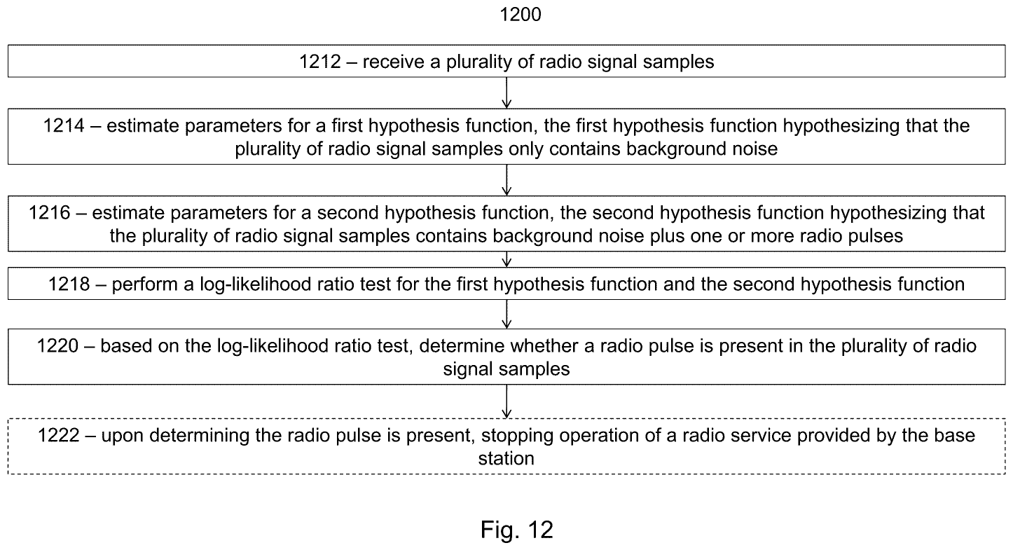

FIG. 12 is a flowchart illustrating an example method in a network node, according to certain embodiments. In particular embodiments, one or more steps of FIG. 12 may be performed by network node 160 described with respect to FIG. 10.

The method begins at step 1212, where the wireless device (e.g., network node 160) receives a plurality of radio signal samples. For example, during operation a network node receives radio signals from user equipment and may also receive radio signals from other sources, such as radar signals.

At step 1214, the network node estimates parameters for a first hypothesis function. The first hypothesis function hypothesizes that the plurality of radio signal samples only contains background noise. At step 1216, the network node estimates parameters for a second hypothesis function. The second hypothesis function hypothesizes that the plurality of radio signal samples contains background noise plus one or more radio pulses. The hypothesis functions are described in more detail above.

In particular embodiments, estimating parameters for the first and the second hypothesis functions comprises using a maximum likelihood estimate for each parameter. Estimating parameters for the first and the second hypothesis functions may comprise estimating any one or more of a start or the end of the one or more radio pulses, width of the one or more radio pulses, spacing between adjacent one or more radio pulses, pulse power and background noise or interference power.

In particular embodiments, the bases station comprises two or more receiver antennas and receiving the plurality of radio signal samples comprises receiving the plurality of radio signal samples at the two or more antennas. Estimating parameters for the first and the second hypothesis functions may comprise estimating a spatial parameter vector that characterizes the channel and/or estimating a direction of arrival. The estimated direction of arrival may comprise an elevation angle of arrival. The estimated direction of arrival may be compared to an expected direction of arrival. Estimating parameters for the first and the second hypothesis functions may comprise estimating a vector of spatial combining weights.

At step 1218, the network node performs a log-likelihood ratio test for the first hypothesis function and the second hypothesis function. The log-likelihood ratio test is performed according to any of the embodiments and examples described herein.

Based on the log-likelihood ratio test, at step 1220 the network node determines whether a radio pulse is present in the plurality of radio signal samples. For example, the network node may determine if the ratio is above or below a particular threshold value. The network node may determine whether a radio pulse is present according to any of the embodiments and examples described herein.

At step 1222, the network node may, upon determining the radio pulse is present, stop operation of a radio service provided by the base station. For example, the network node may stop serving user equipment until the determined radio pulse is no longer present.

Modifications, additions, or omissions may be made to method 1200 of FIG. 12. Additionally, one or more steps in the method of FIG. 12 may be performed in parallel or in any suitable order.

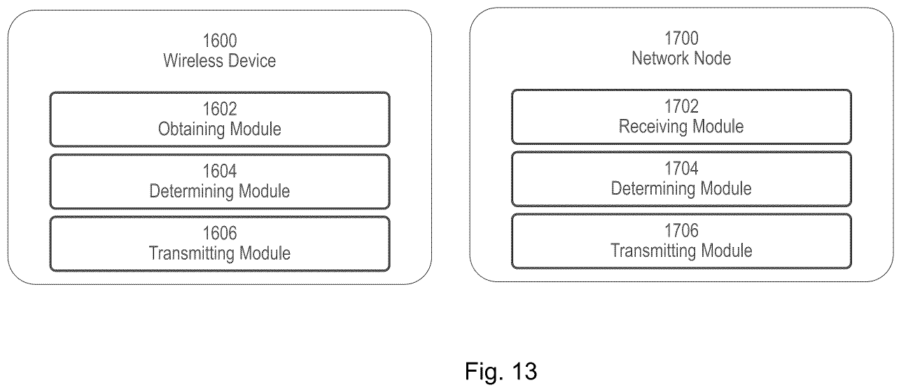

FIG. 13 illustrates a schematic block diagram of two apparatuses in a wireless network (for example, the wireless network illustrated in FIG. 10). The apparatuses include a wireless device and a network node (e.g., wireless device 110 and network node 160 illustrated in FIG. 3). Apparatuses 1600 and 1700 are operable to carry out the example methods described with reference to FIG. 12, and possibly any other processes or methods disclosed herein. It is also to be understood that the method of FIG. 12 is not necessarily carried out solely by apparatuses 1600 and/or 1700. At least some operations of the method may be performed by one or more other entities.

Virtual apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause obtaining module 1602, determining module 1604, transmitting module 1606, and any other suitable units of apparatus 1600 to perform corresponding functions according one or more embodiments of the present disclosure.

In some implementations, the processing circuitry may be used to cause receiving module 1702, determining module 1704, transmitting module 1706, and any other suitable units of apparatus 1700 to perform corresponding functions according one or more embodiments of the present disclosure.

As illustrated in FIG. 13, apparatus 1600 includes obtaining module 1602 configured to wireless signals according to any of the embodiments and examples described herein. Apparatus 1600 also includes determining module 1604 configured to determine a presence of a radio signal according to any of the embodiments and examples described herein. Transmitting module 1606 is configured to transmit uplink signals according to any of the embodiments and examples described herein.

As illustrated in FIG. 13, apparatus 1700 includes receiving module 1702 configured to receive radio signals according to any of the embodiments and examples described herein. Apparatus 1700 also includes determining module 1704 configured to determine a presence of a radio signal according to any of the embodiments and examples described herein. Transmitting module 1606 is configured to transmit downlink signals according to any of the embodiments and examples described herein.

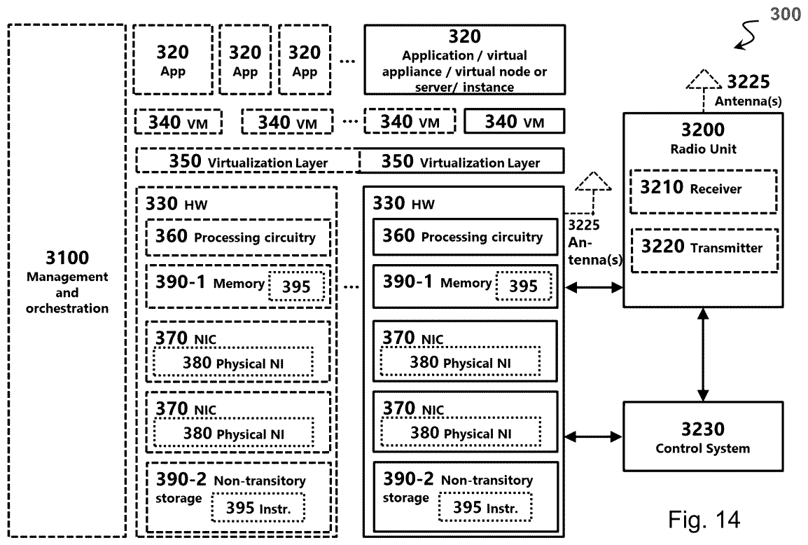

FIG. 14 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 14, hardware 330 may be a standalone network node with generic or specific components. Hardware 330 may comprise antenna 3225 and may implement some functions via virtualization. Alternatively, hardware 330 may be part of a larger cluster of hardware (e.g., such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

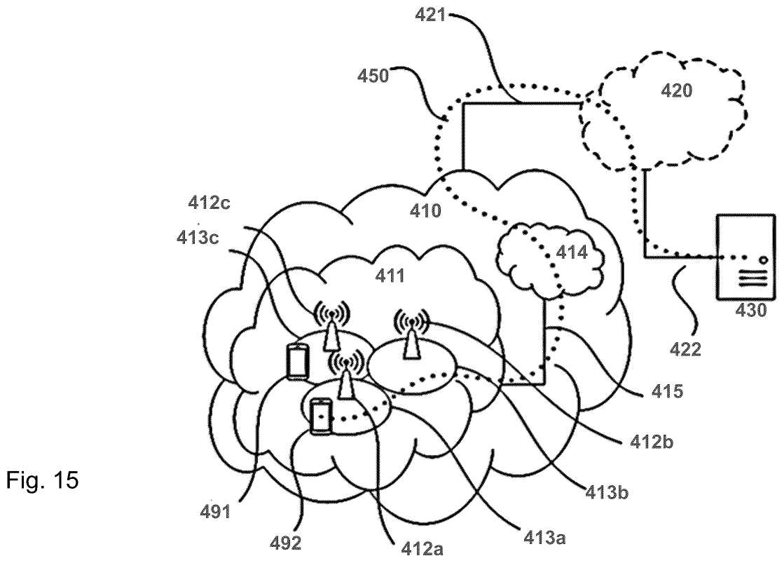

Still in the context of NFV, Virtual Network Function (VNF) is responsible for handling specific network functions that run in one or more virtual machines 340 on top of hardware networking infrastructure 330 and corresponds to application 320 in FIG. 15.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

With reference to FIG. 15, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 15 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

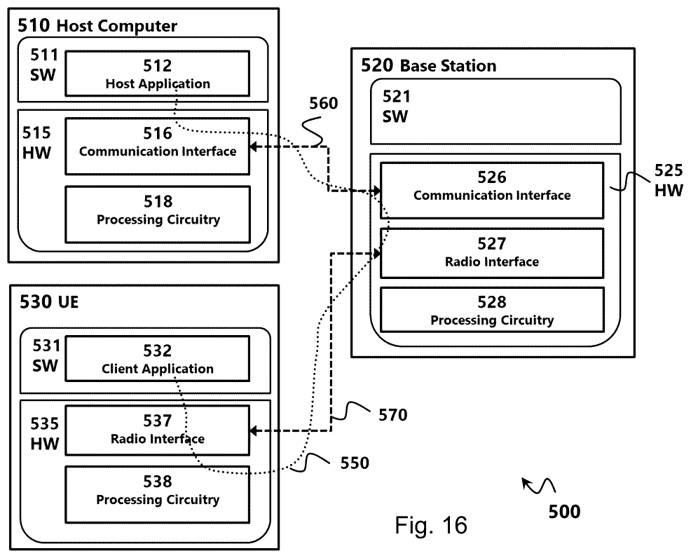

FIG. 16 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 16. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512.

Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 16) served by base station 520. Communication interface 526 may be configured to facilitate connection 560 to host computer 510. Connection 560 may be direct, or it may pass through a core network (not shown in FIG. 16) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at

UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 16 may be similar or identical to host computer 430, one of base stations 412a, 412b, 412c and one of UEs 491, 492 of FIG. 15, respectively. This is to say, the inner workings of these entities may be as shown in FIG. 16 and independently, the surrounding network topology may be that of FIG. 15.

In FIG. 16, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, and thereby provide benefits such as reduced user waiting time, better responsiveness and extended battery life.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

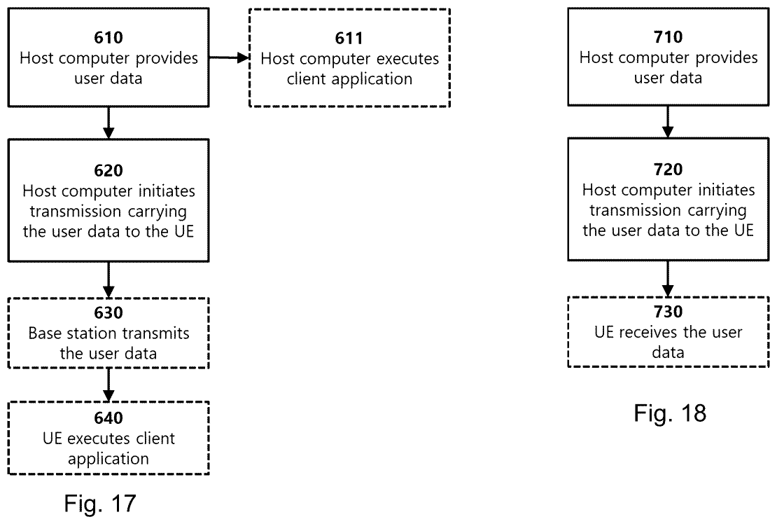

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

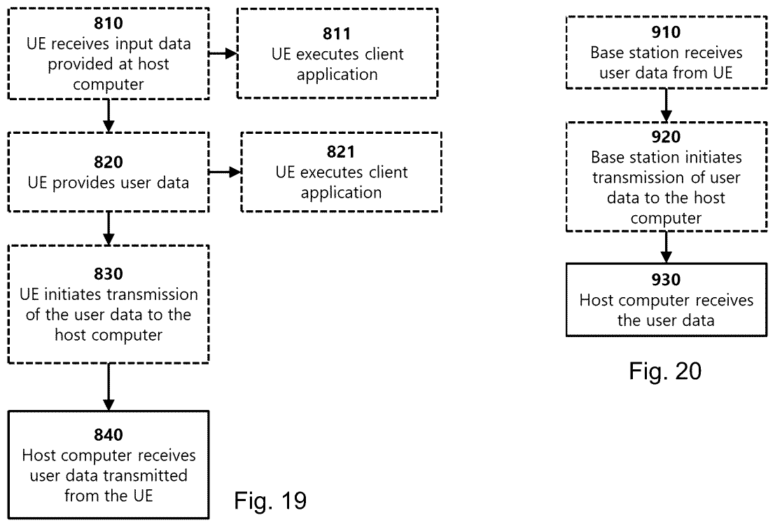

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a network node for detecting a radio pulse, the method comprising:
receiving a plurality of radio signal samples:
estimating parameters for a first hypothesis function, the first hypothesis function hypothesizing that the plurality of radio signal samples only contains background noise:
estimating parameters for a second hypothesis function, the second hypothesis function hypothesizing that the plurality of radio signal samples contains background noise plus one or more radio pulses:
performing a log-likelihood ratio test for the first hypothesis function and the second hypothesis function; and
based on the log-likelihood ratio test, determining whether a radio pulse is present in the plurality of radio signal samples.

2. The method of claim 1, wherein estimating parameters for the first and the second hypothesis functions comprises using a maximum likelihood estimate for each parameter.

3. The method of claim 1 wherein estimating parameters for the first and the second hypothesis functions comprises estimating any one or more of a start or the end of the one or more radio pulses, width of the one or more radio pulses, spacing between adjacent one or more radio pulses, pulse power and background noise or interference power.

4. The method of claim 1, wherein the bases station comprises two or more receiver antennas, and wherein receiving the plurality of radio signal samples comprises receiving the plurality of radio signal samples at the two or more antennas.

5. The method of claim 4, wherein estimating parameters for the first and the second hypothesis functions comprises estimating a spatial parameter vector that characterizes the channel.

6. The method of claim 4, wherein estimating parameters for the first and the second hypothesis functions comprises estimating a direction of arrival.

7. The method of claim 6, wherein the estimated direction of arrival comprises an elevation angle of arrival.

8. The method of claim 6, wherein the estimated direction of arrival is compared to an expected direction of arrival.

9. The method of claim 4, wherein estimating parameters for the first and the second hypothesis functions comprises estimating a vector of spatial combining weights.

10. The method of claim 1, further comprising upon determining the radio pulse is present, stopping operation of a radio service provided by the base station.

11. A network node comprising processing circuitry operable to:
receive a plurality of radio signal samples;
estimate parameters for a first hypothesis function, the first hypothesis function hypothesizing that the plurality of radio signal samples only contains background noise:
estimate parameters for a second hypothesis function, the second hypothesis function hypothesizing that the plurality of radio signal samples contains background noise plus one or more radio pulses:
perform a log-likelihood ratio test for the first hypothesis function and the second hypothesis function; and
based on the log-likelihood ratio test, determine whether a radio pulse is present in the plurality of radio signal samples.

12. The network node of claim 11, wherein the processing circuitry is operable to estimate parameters for the first and the second hypothesis functions by using a maximum likelihood estimate for each parameter.

13. The network node of claim 11, wherein the processing circuitry is operable to estimate parameters for the first and the second hypothesis functions by estimating any one or more of a start or the end of the one or more radio pulses, width of the one or more radio pulses, spacing between adjacent one or more radio pulses, pulse power and background noise or interference power.

14. The network node of claim 11, wherein the bases station comprises two or more receiver antennas, and wherein the processing circuitry is operable to receive the plurality of radio signal samples by receiving the plurality of radio signal samples at the two or more antennas.

15. The network node of claim 14, wherein the processing circuitry is operable to estimate parameters for the first and the second hypothesis functions by estimating a spatial parameter vector that characterizes the channel.

16. The network node of claim 14, wherein the processing circuitry is operable to estimate parameters for the first and the second hypothesis functions by estimating a direction of arrival.

17. The network node of claim 16, wherein the estimated direction of arrival comprises an elevation angle of arrival.

18. The network node of claim 16, wherein the estimated direction of arrival is compared to an expected direction of arrival.

19. The network node of claim 14, wherein estimating parameters for the first and the second hypothesis functions comprises estimating a vector of spatial combining weights.

20. The method of claim 11, the processing circuitry further operable to, upon determining the radio pulse is present, stop operation of a radio service provided by the base station.
